(19) United States
(12) Patent Application Publication
(10) Pub. No.: US 2006/0140348 A1
(43) Pub. Date: Jun. 29, 2006

(54) System and method for providing depot repair services for information technology equipment

(76) Inventors: James H. Wallace, Powell, OH (US); Craig J. Wallace, Westerville, OH (US)

Correspondence Address: Porter, Wright, Morris & Arthur LLP;ATTN: Intellectual Property Department, 28th Floor, 41 South High Street, Columbus, OH, 43215-6194, US

(21) Appl. No.: 11/025,888

(22) Filed: Dec. 29, 2004

(51) Int. Cl. H04M 1/24

(52) U.S. Cl. 379/29.01

(57) ABSTRACT

A method for providing repair services comprising the steps of providing a plurality of repair credits associated with a predetermined model of equipment to a customer where the customer has a plurality of units of the predetermined model of equipment. A submitted one of the plurality of units is received from the customer and the submitted unit is repaired in exchange for at least one of the repair credits. The submitted unit is returned to the customer after repair. It is noted that any of the plurality of repair credits can be exchanged for repair of any of the plurality of units so that a one-for-many repair contract is provided rather than a traditional one-for-one repair contract.

### CROSS-REFERENCE TO RELATED APPLICATIONS

Not Applicable.

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to a system and method for providing depot repair services and, more particularly, to such a system and methods where customers can have large quantities of a particular of model of equipment repaired.

### BACKGROUND OF THE INVENTION

Users of large quantities of equipment such as, for example, computer systems or other information technology equipment frequently face the problem of needing repairs. When non mission-critical equipment needs repair, the equipment is often sent to a depot repair center where it is repaired and then returned to the user. The user often has service agreements for the equipment with a repair service provider. These service agreements are each for a specific unit of equipment which is typically identified in the service agreement by serial number. Thus users often have a large quantity of service agreements which are separately purchased. If equipment in need of repair does not have a service agreement, the user must provide a purchase order for repair services to the repair service provider. Obtaining internal approvals for the purchase order can often be a time consuming process. Therefore, managing the repair of a large quantity of equipment can be a time consuming and expensive undertaking.

In recent years, there appears to be a shift in strategy among corporations to meet demands for information technology equipment. Rather than, acquiring “high-end” machines/equipment, larger quantities of “low-end” machines/equipment are being acquired. These low end machine/equipment, of course, do not hold up as well over time. Thus corporations are faced with deciding between repairing of the equipment, with the problems of managing an ever growing number of service contracts, or replacing the equipment upon failure, with the problems of managing an ever growing rate of attrition. Accordingly, there is a need in the art for an improved system and method for providing and/or managing repair services for equipment.

### SUMMARY OF THE INVENTION

The present invention provides a system and method which overcomes at least some of the above-noted problems of the related art. According to one embodiment of the present invention, a method for providing repair services comprises the steps of providing plurality of repair credits associated with a predetermined model of equipment to a customer where the customer has a plurality of units of the predetermined model of equipment. A submitted one of the plurality of units is received from the customer and the submitted unit is repaired in exchange for at least one of the repair credits. The submitted unit is returned to the customer after repair. Any of the plurality of repair credits can be exchanged for repair of any of the plurality of units.

According to another aspect of the present invention, a method for providing repair services comprises the steps of providing a plurality of repair credits associated with a predetermined model of equipment to a customer where the customer has a plurality of units of the predetermined model of equipment. The predetermined model of equipment is a predetermined model of information technology equipment and each of the plurality of units has a unique serial number. An Internet portal is provided through which the customer can order the plurality of repair credits. A submitted one of the plurality of units is received from the customer and the submitted unit is repaired in exchange for at least one of the repair credits. The submitted unit is returned to the customer after repair. Any of the plurality of repair credits can be exchanged for repair of any of the plurality of units.

According to another aspect of the present invention, an Internet-implemented system for providing repair services to a customer comprises a server system connected to the Internet and configured to receive requests from the customer for repair credits associated with a predetermined model of equipment where the customer has a plurality of units of the predetermined model of equipment. The server system is also configured to provide notification to the customer to submit one of the plurality of units for repair in exchange for at least one of the repair credits and provide information relating to the submitted unit.

From the foregoing disclosure and the following more detailed description of various preferred embodiments it will be apparent to those skilled in the art that the present invention provides a significant advance in the technology and art of systems and methods of repairing equipment. Particularly significant in this regard is the potential the invention affords for providing an efficient, high quality, easy to use, reliable system and method which enables budgeting and control. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a diagrammatic view of a system for providing repair services according to the present invention;

FIG. 2 is a diagrammatic view of an exemplary embodiment of a log-in interface of a service management portal of the system of FIG. 1;

FIG. 3 is a diagrammatic view of an exemplary embodiment of a home page of the service management portal of the system of FIG. 1;

FIG. 4 is a diagrammatic view of an exemplary embodiment of an associated customer interface of the service management portal of the system of FIG. 1;

FIG. 5 is a diagrammatic view of an exemplary embodiment of an associated contracts interface of the service management portal of the system of FIG. 1;

FIG. 6 is a diagrammatic view of an exemplary embodiment of an associated product interface of the service management portal of the system of FIG. 1;

FIG. 7 is a diagrammatic view of an exemplary embodiment of credit request interface of the service management portal of the system of FIG. 1;

FIG. 8 is a diagrammatic view of an exemplary embodiment of a new credit case interface of the service management portal of the system of FIG. 1;

FIG. 9 is a diagrammatic view of an exemplary embodiment of a new credit case submitted notification of the service management portal of the system of FIG. 1; and

FIG. 10 is a flow chart showing a method for providing repair services with the system of FIG. 1.

It should be understood that the appended drawings are not necessarily to scale, presenting a somewhat simplified representation of various preferred features illustrative of the basic principles of the invention. The specific design features of the system and method disclosed herein will be determined in part by the particular intended application and use environment.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved system and method for providing repair services disclosed herein. The following detailed discussion of various alternative and preferred embodiments will illustrate the general principles of the invention with reference to a system and method for providing repair services for information technology equipment. Other embodiments suitable for other applications will be apparent to those skilled in the art given the benefit of this disclosure.

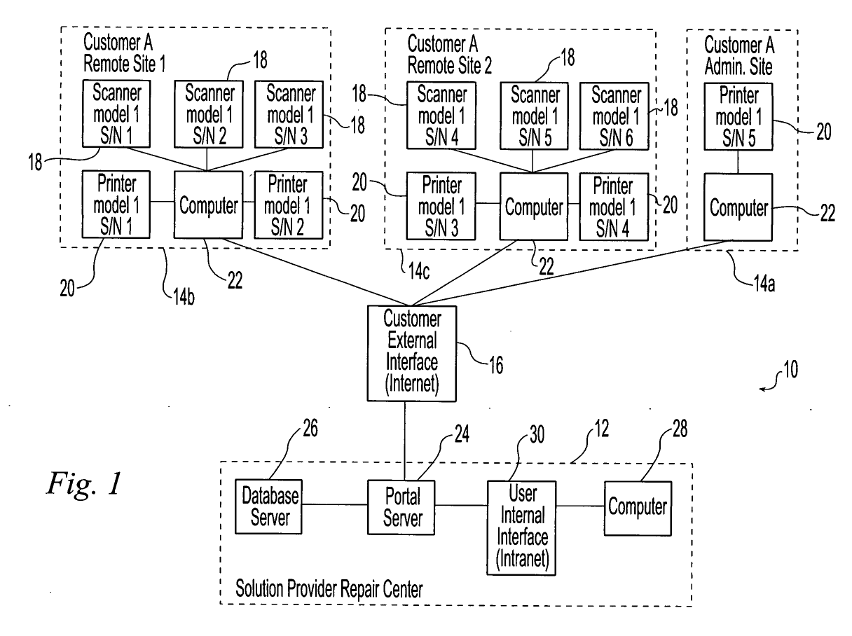

Referring now to the drawings, FIG. 1 shows a system 10 for providing and/or managing repair services according to a preferred embodiment of the present invention. The system 10 enables a customer to purchase a plurality of repair credits associated with a predetermined product or model under a single contract. The contract thus covers multiple units or serial numbers of the specific product or model type. The customer can then exchange the repair credits for repair of any unit or serial number of the specific product or model type covered by the contract. The illustrated system 10 includes components at a solution provider site or repair center 12 components at customer sites 14a, 14 b, 14c and which is remote from the repair center 12. While the illustrated system 10 includes a single customer (Customer A) having an administrative site 14a and two remote sites 14b, 14c, it is noted that any number of customers can be included and each customer can have any number of sites within the scope of the present invention. In fact it is contemplated that the system 10 can include a large number of customers with each customer having a large number of sites. It is also noted that there can be more than one depot or repair center 12 and/or the equipment can actually be received for repair at a corporate entity/warehouse site of the customer. Information systems at the illustrated sites 12, 14 are in communication via the Internet 16. It is noted, however, that alternatively any other suitable external interface or communication connection can be utilized such as, for example, an intranet or dial up connection.

Located at the customer sites 14a, 14b, 14c are models or products of equipment 18, 20. Included are a plurality of units of each type of product 18, 20 and each unit is preferably provided with a unique serial number. The illustrated sites 14a, 14b, 14c have a plurality of information technology equipment in the form of a plurality of scanners 18 and a plurality of printers 20. It is noted, however, that the information technology equipment 18, 20 can alternatively be of any other suitable type such as, for example, central processing units (CPUs), tape drives, disk drives, other storage devices, monitors, display screens, printers, other output devices, keyboards, mice, scanners, other input devices, servers, modems, other communications devices, photocopiers, other multi-purpose devices, or like equipment like, and/or the products 18, 20 can alternatively be any other suitable kind of equipment other than the information technology equipment. The term “information technology equipment” is used in this specification and claims to mean all equipment used in connection with managing and processing information by computers. Each illustrated customer site 14a, 14b, 14c is also provided with a computer or other suitable device 22 for providing the user access to the Internet 16.

The illustrated system 10 includes at least one portal server 24, a database server 26, and a computer or other suitable device 28 for providing the user access to the system 10 through an internal interface 30 such as the illustrated intranet. The illustrated portal server 24 is located at the solution provider site 12 and provides a portal for the customer. The term “portal” means a front-end interface or web interface which provides a communication channel, preferably a secure communication channel. The portal server 24 can be based on any suitable processor and can run any suitable operating system. The portal server 24 provides a front-end interface to data in the database 26 and elsewhere on the Internet 16 utilizing a web browser interface.

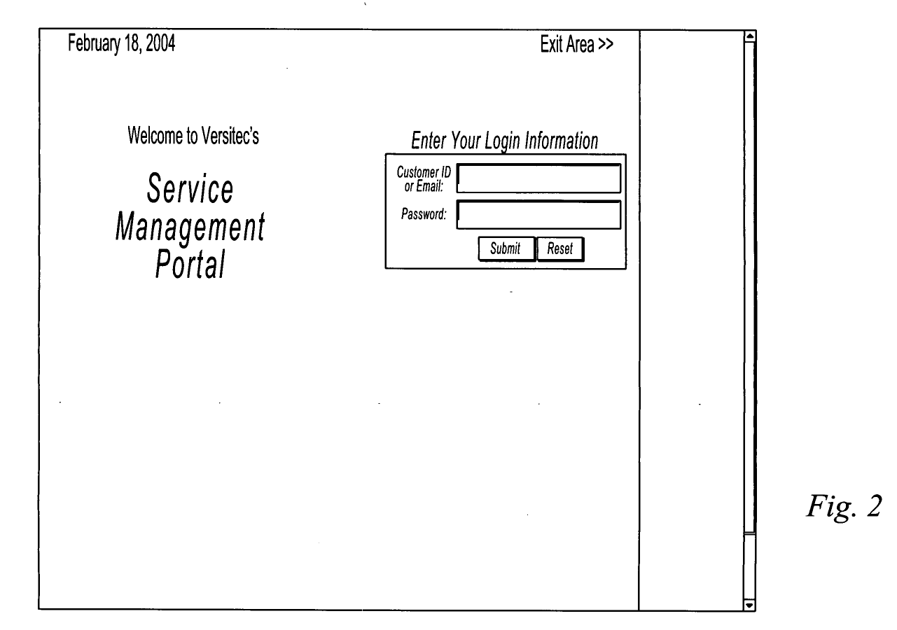

The illustrated portal server 24 is configured to provide a repair service management portal according to a preferred embodiment of the present invention. FIG. 2 shows an exemplary embodiment of a customer log-in interface used by the customer to access the service management portal. The customer accesses the log-in interface via the Internet 16 and enters its unique customer ID and password into the indicated fields. Typically, the customer has preferably obtained its unique password from the solution provider. With the appropriate data entered into the fields, the customer selects submit to display a home page of the service management portal.

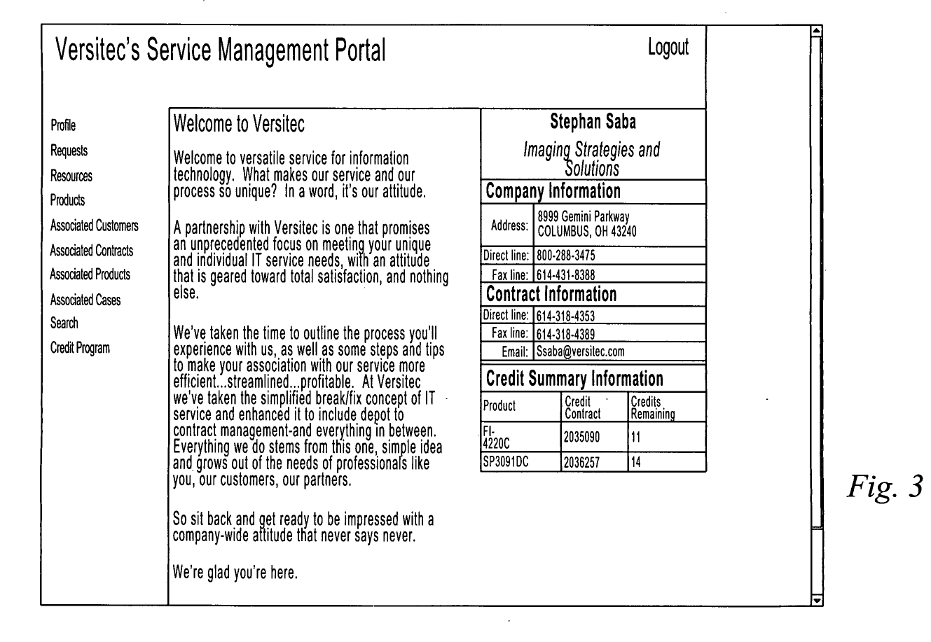

FIG. 3 shows an exemplary embodiment of a homepage of the service management portal. The homepage enables an administrator of the customer to access information and make requests in order for the customer to manage repair services. The illustrated homepage is customized for the customer and includes a name of the customer's administrator, a name of the customer, company information about the customer, contact information for the customer, and credit summary information for the customer. The illustrated credit summary information includes a listing of products, contract numbers for each of the products, and quantity of repair credits remaining for each product. The illustrated homepage also includes links to Profile, Requests, Resources, Products, Associated Customers, Associated Contracts, Associated Products, Associated Cases, Search, and Credit Program. The illustrated Profile link directs the customer to a customer profile interface where information regarding the customer can be viewed and updated. The illustrated Requests link directs the customer to a customer request interface where the customer can make requests such as, for example, offer suggestions for new product feature or ask questions about upgrades or product offerings. The illustrated Resources link directs the customer to a customer resources interface where the customer download information such as, for example, reference lists, manuals, or contracts. The illustrated Products link directs the customer to a products interface where the customer can search for information regarding various products.

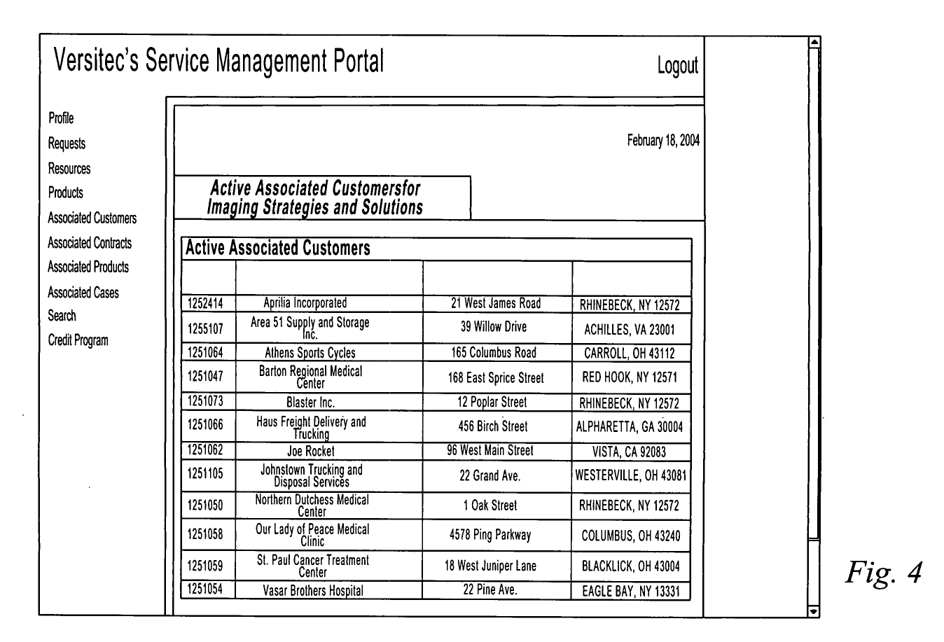

The illustrated Associated Customers link directs the customer to an associated customers interface. FIG. 4 shows an exemplary embodiment of an associated customers interface of the illustrated service management portal. The illustrated associated customers interface provides a listing of customers which are actively associated with the administrator accessing the portal. It is noted that a single administrator can thereby manage repair services for any number of companies. The illustrated interface identifies the active associated customers by customer number, name, and address.

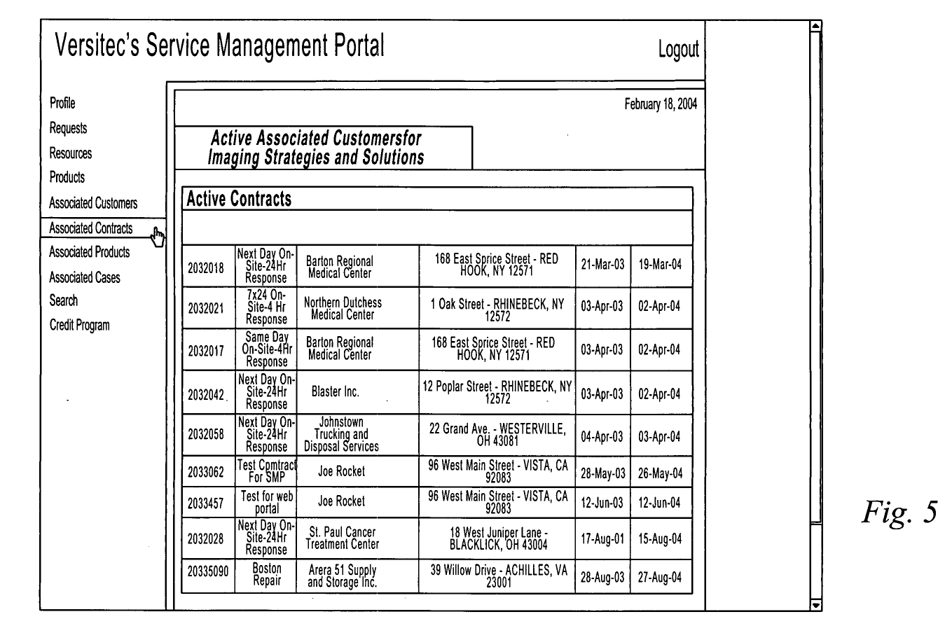

The illustrated Associated Contracts link directs the customer to an associated customer contracts interface. FIG. 5 shows an exemplary embodiment of an associated customer contracts interface of the illustrated service management portal. The illustrated associated customer contracts interface provides a listing of active contracts which are associated with the administrator accessing the portal. It is noted that a single administrator can thereby manage any number of service contracts. The illustrated interface identifies the active associated customer contracts by contract number, contract type, company name, company site address, contract start date and contract end date.

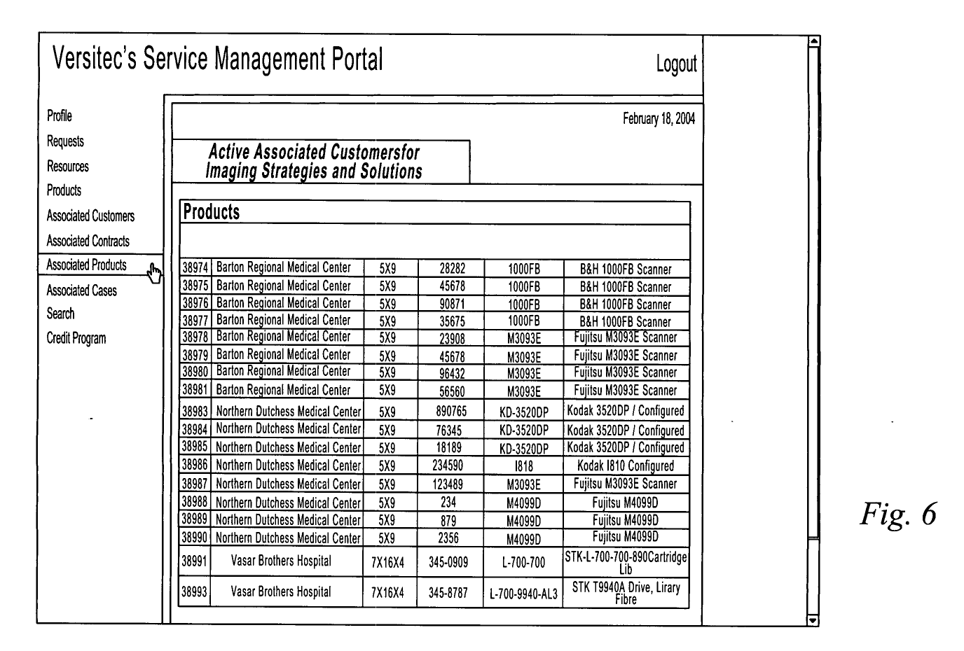

The illustrated Associated Products link directs the customer to an associated products interface. FIG. 6 shows an exemplary embodiment of an associated products interface of the illustrated service management portal. The illustrated associated products interface provides a listing of active products which are associated with the administrator accessing the portal. It is noted that a single administrator can thereby manage any number of products or models and any number of specific units of those products or models. The illustrated interface identifies the active associated products by product ID number, company name, level of support, model number, and equipment description.

The illustrated Associated cases link directs the customer to a customer associated cases interface where the customer can view information regarding the status of pending and completed cases. The illustrated Search link directs the customer to a search interface where the customer can search for information on the service management portal.

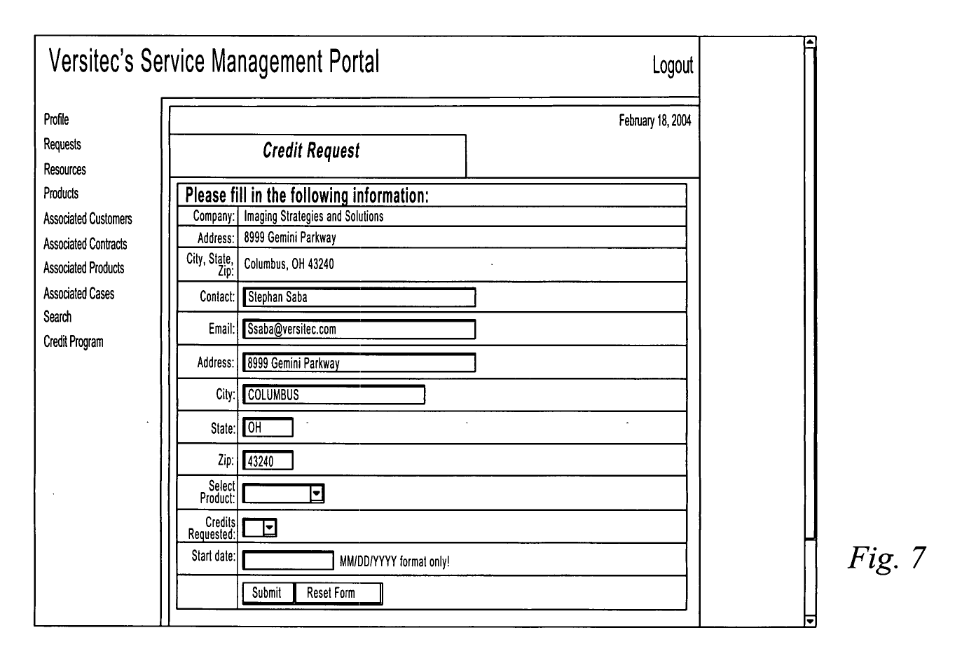

The illustrated Credit Program link directs the customer to a credit program interface where the customer can choose between requesting repair credits to be used in exchange for repairing a unit of a predetermined model of equipment and submitting a unit for repair in exchange for one of the repair credits. If the customer chooses to request repair credits they are directed to a credit request interface. FIG. 7 shows an exemplary embodiment of a credit request interface of the illustrated service management portal. The illustrated credit request interface provides fields for identifying information related to requesting a contract for repair credits associated with a particular product model of equipment. The illustrated interface identifies the name and address of the customer and enables the customer to modify information relating to a company contact, email and address. The illustrated credit request interface provides fields for identifying the product or model of equipment to be associated with the contract, the number of repair credits to be purchased under the contract, and the start date of the contract. It is noted that the customer can request one or more repair credits under a single contract. Preferably the customer requests a plurality of repair credits in order to take advantage of the efficiencies of multiple repairs under one contract and purchase order. It is noted that the service provider can provide a plurality of predetermined quantities of repair credits available for purchase under one contract such as, for example, 5, 10, and 15 if desired. It is also noted that the service provider can vary the price of the repair credits depending on the quantity purchased if desired. The service provider can predetermine the contract term such as, for example, one year or any other suitable period of time. However, the contract can alternatively terminate upon use of all of the repair credits or could have no termination date. Preferably, the repair credits expire if not used by the end of the contract term. However, the repair credits can alternatively have no expiration date, be at least partially carryover to a subsequent contract, or be at least partially exchangeable or refundable after the term of the contract. Once the customer request the repair credits, the service provider arranges to complete the purchase. It should be appreciated that the customer is able to purchase a plurality of repair credits on a single purchase order. Once the purchase of repair credits is complete, the customer is notified of the new contract.

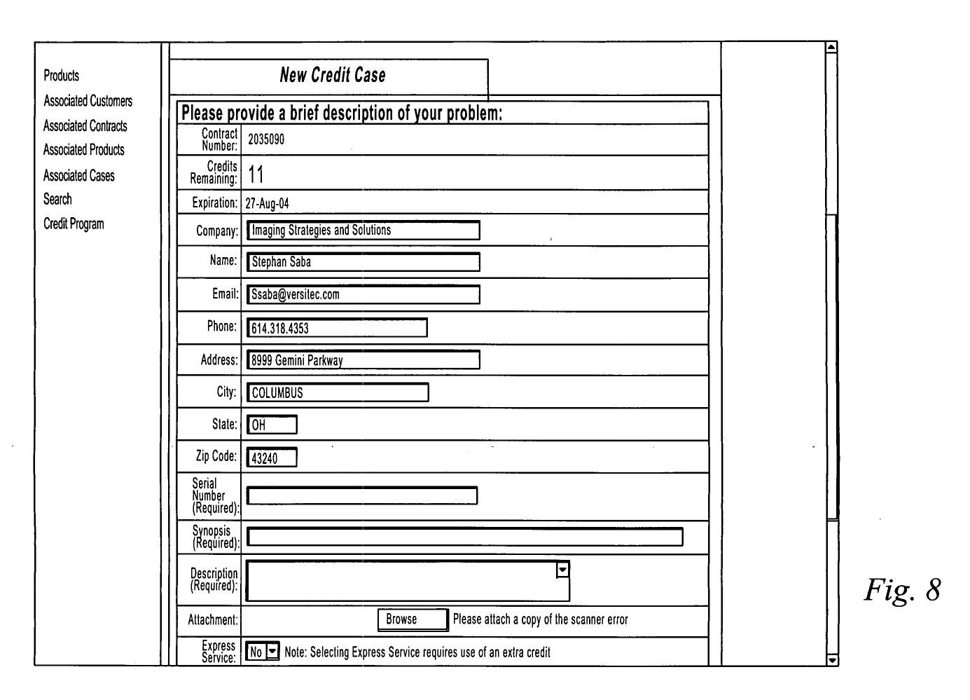

If the customer chooses to submit a unit for repair they are directed to a new credit case interface. FIG. 8 shows an exemplary embodiment of a new credit case interface of the illustrated service management portal. The illustrated new credit case interface provides fields for identifying information related to a unit for repair in exchange for a repair credit under an existing contract for the particular product or model. The illustrated interface identifies the contract number, the number of credits remaining under the contract, and the expiration date of the contract and enables the customer to modify information relating to a company contact, email and address. The illustrated credit request interface provides fields for identifying the unique serial number for the specific unit to be repaired, a synopsis and description of the problem with the unit to be repaired. The illustrated interface permits the attachment of documents such as, for example, a copy of a scanner error. The illustrated interface also permits the customer to request express service which in the illustrated embodiment requires the use of an extra repair credit.

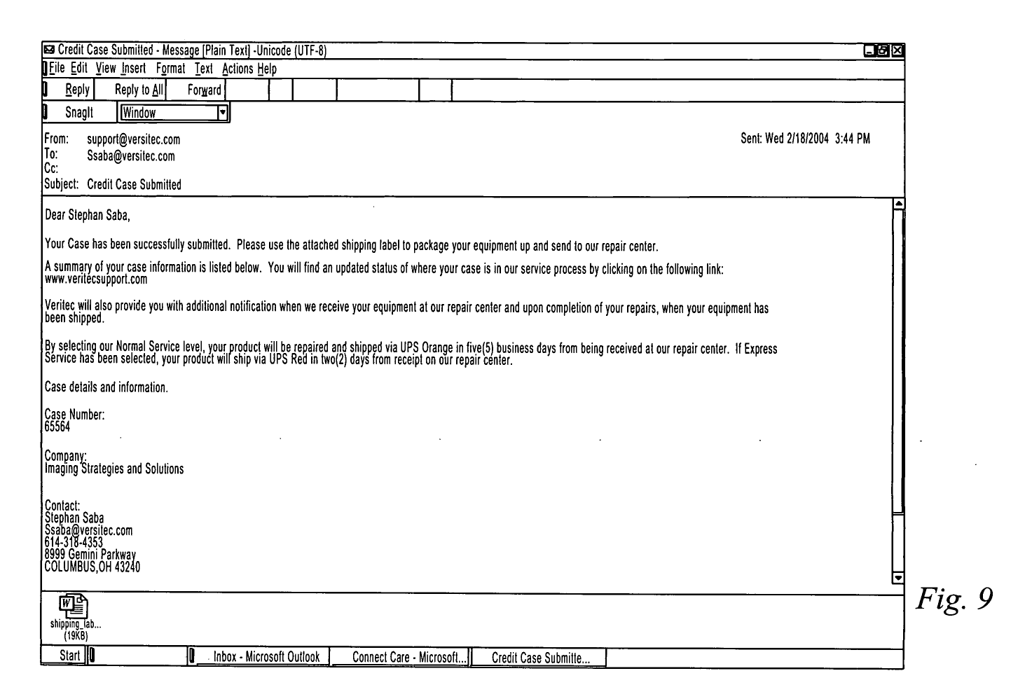

Once the customer submits a new credit case, the submission is verified by the service provider and the service provider sends the customer, preferably by email, new credit case submitted notification. FIG. 9 shows an exemplary embodiment of a new credit case submitted notification of the illustrated service management portal. The notification informs the customer that the case was successfully submitted and attaches a shipping label to be used by the customer to ship the unit to be repaired to the repair center. Preferably, additional notices are sent to the customer when the unit is received at the repair center, upon completion of the repairs, and when the unit has been shipped back to the customer.

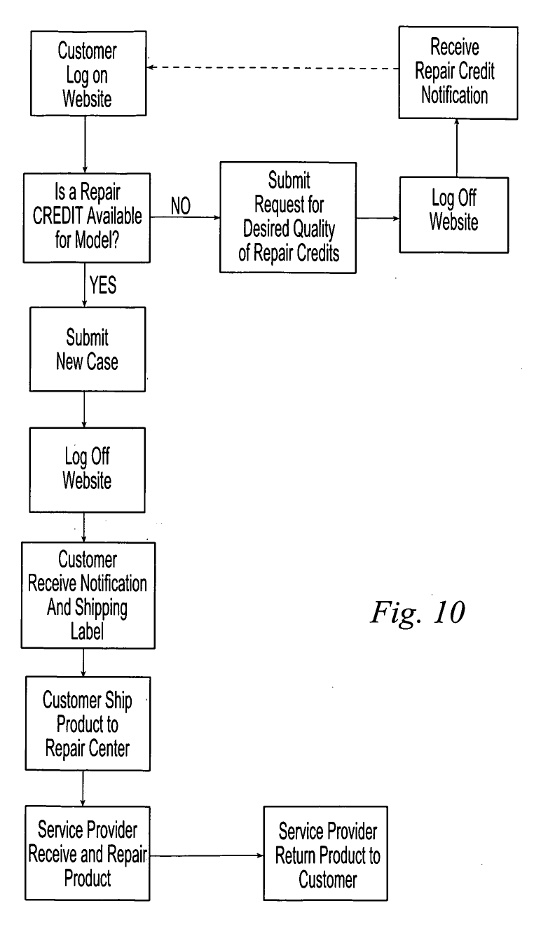

FIG. 10 shows a flow chart of a customer utilizing the service management portal described hereinabove to have a unit of equipment repaired. An existing customer logs onto the portal via the Internet. The customer must check to see if the customer has an existing contract with remaining repair credits associated with the specific product or model of equipment of which the unit to be repaired belongs. If not, the customer must go to the credit request interface (FIG. 7) and request to purchase repair credits for the particular product or model of the unit to be repaired. The customer then must log off of the portal and wait until the purchase of the proper repair credits is complete.

If the customer has remaining repair credits associated with the appropriate product or model, or has now purchased new repair credits associated with the appropriate product or model, they can go to the new credit case interface (FIG. 8) and submit a new case for repair of the unit in exchange for at least one of the remaining repair credits. The customer can then log off of the portal. Preferably, there are at least two service levels such as, for example, normal service and expedited service that are provided in exchange for differing quantities of the repair credits. For example, normal service can be turnaround of about five days from receipt and provided for one of the repair credits and expedited service can be turnaround of about two days from receipt and provided for two or more of the repair credits. It is noted, however, that alternatively there can be a single service level or more than two service levels, the turnaround times can be greater or lesser, and/or the required repair credits can be greater or lesser. Once the service provider verifies the submittal, the portal sends notification to the customer of the successful submittal along with a shipping label. The customer then uses the shipping label to ship the unit to the repair center which can be at one or more locations of the service provider or can alternatively be corporate entity/warehouse site of the customer such as the illustrated administrative site 14a. Upon receipt of the unit, the service provider notifies the customer. The service provider then repairs the unit and notifies the customer upon completion of repairs. The service provider then return ships the unit to the customer and notifies the customer upon shipment. The process is repeated each time the customer desires to have a unit repaired in exchange for an associated repair credit.

It should be apparent that the service management portal provides documentation for corporate control of the repair of equipment at a large number of remote sites. The system is site location neutral, that is, the manager of repair services does not have to be located where the equipment is located. Thus, repair services can be managed at corporate administrative location, at branch locations of the corporation, or at the solution provider itself. The portal also enables increased authority by branch equipment users or corporate because the branch users can identify problems and request repairs while the corporate authority can authorize the requests. The system also provides the manager with the ability to see which users are consuming the credits and how often. This information can be utilized to determined if there are problems with particular offices or individuals or with particular manufacturers or models of equipment.

From the foregoing disclosure and detailed description of certain preferred embodiments of the present invention, it is apparent that the need for purchase orders and/or approvals on each service contract is reduced by covering multiple units or serial numbers (all of the same product or model) under a single contract. Thus the benefit of contractual coverage is obtained without the expense of typical one-to-one service agreements. It is also apparent that the repair credit system of the present invention provides customers with ease of use; auditing of repairs; budgeting, tracking, inventory management, equipment performance; timely return of equipment, repairs of service and functionality; flexibility on service options; cost allocation; and control and accountability of use. It is further apparent that the portal allows a customer to manage its accounts and credits through a single point of contact with the ability of reporting, tracking, notification and flow. As a result the customer achieves greater flexibility, increased productivity, reduced downtime, and improved budget allocation and account management.

From the foregoing disclosure and detailed description of certain preferred embodiments of the present invention, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A method for providing repair services comprising the steps of:
providing a plurality of repair credits associated with a predetermined model of equipment to a customer;
wherein the customer has a plurality of units of the predetermined model of equipment;
receiving a submitted one of the plurality of units from the customer;
repairing the submitted unit in exchange for at least one of the repair credits;
returning the submitted unit to the customer after repair; and
whereby any of the plurality of repair credits can be exchanged for repair of any of the plurality of units.

2. The method according to claim 1, wherein a predetermined plurality of the repair credits are provided to the customer.

3. The method according to claim 2, wherein the predetermined plurality of repair credits is one of several predetermined pluralities of repair credits available to the customer.

4. The method according to claim 1, further comprising the step of expiring the plurality of repair credits after a predetermined period of time.

5. The method according to claim 4, further comprising the step of expiring the plurality of repair credits after one year.

6. The method according to claim 1, wherein a purchase order is not required for the customer to send the submitted unit.

7. The method according to claim 1, wherein the predetermined model of equipment is a predetermined model of information technology equipment.

8. The method according to claim 7, wherein the predetermined model of information technology equipment is a predetermined model of one of a scanner and a printer.

9. The method according to claim 1, wherein the submitted unit is received at a central depot and the plurality of units of the customer are located at a plurality of locations remote from the depot.

10. The method according to claim 1, further comprising the step of providing notification to the customer to send the submitted unit.

11. The method according to claim 1, further comprising the step of providing an Internet portal through which the customer can order the plurality of repair credits.

12. The method according to claim 11, wherein authorization is provided to the customer through the Internet portal to send the submitted unit.

13. The method according to claim 11, wherein the customer can view information relating to the submitted unit prior to the submitted unit being returned to the customer.

14. The method according to claim 11, wherein the customer can view information relating to the submitted unit after the submitted unit is returned to the customer.

15. The method according to claim 11, wherein each of the plurality of units has a unique serial number.

16. The method according to claim 11, wherein the customer can select one of at least two service levels having differing turnaround times and provided in exchange for differing quantities of the repair credits.

17. An Internet-implemented method for providing repair services comprising the steps of:
providing a plurality of repair credits associated with a predetermined model of equipment to a customer;
wherein the customer has a plurality of units of the predetermined model of equipment;
wherein the predetermined model of equipment is a predetermined model of information technology equipment;
wherein each of the plurality of units has a unique serial number;
providing an Internet portal through which the customer can order the plurality of repair credits;
receiving a submitted one of the plurality of units from the customer;
repairing the submitted unit in exchange for at least one of the repair credits;
returning the submitted unit to the customer after repair; and
whereby, any of the plurality of repair credits can be exchanged for repair of any of the plurality of units.

18. The method according to claim 17, wherein notification is provided to the customer through the Internet portal to send the submitted unit.

19. The method according to claim 17, wherein the customer can view information relating to the submitted unit prior to the submitted unit being returned to the customer.

20. The method according to claim 17, wherein the customer can view information relating to the submitted unit after the submitted unit is returned to the customer.

21. The method according to claim 17, wherein the predetermined model of information technology equipment is a predetermined model of one of a scanner and a printer.

22. The method according to claim 17, wherein the customer can select one of at least two service levels having differing turnaround times and provided in exchange for differing quantities of the repair credits.

23. An Internet-implemented system for providing repair services to a customer, said system comprising:
a server system connected to the Internet and configured to:
receive requests from the customer for repair credits associated with a predetermined model of equipment where a customer has a plurality of units of the predetermined model of equipment;
provide notification to the customer to submit one of the plurality of units for repair in exchange for at least one of the repair credits; and
provide information relating to the submitted unit.
